(19) United States
(12) Patent Application Publication
(10) Pub. No.: US 2010/0119666 A1
(43) Pub. Date: May 13, 2010

(54) Frozen packaged sushi and method of thawing frozen packaged sushi

(76) Inventor: Koichi Asano, Nagoya (JP)

Correspondence Address: CLARK & BRODY, 1090 VERMONT AVENUE, NW, SUITE 250, WASHINGTON, DC, 20005, US

(21) Appl. No.: 12/309,071

(22) PCT Filed: Jun. 29, 2007
(86) PCT No.: PCT/JP2007/063099

§ 371 Date: Nov. 30, 2009

(30) Foreign Application Priority Data
Jul. 12, 2006 (JP) 2006-191305

(51) Int. Cl. A23L 3/365; A23B 4/10

(52) U.S. Cl. 426/125; 426/524

(57) ABSTRACT

To develop a frozen packaged sushi which can be spontaneously thawed and a method of thawing a frozen packaged sushi. [MEANS FOR SOLVING PROBLEMS] (1) A frozen packaged sushi having been packaged in a plastic film and sealed, characterized in that the sugar content of cooked rice constituting the sushi is from 7.0 to 12.0%, and use is made of cooked rice prepared preferably by heating rice from room temperature to 98° C. within 10±2 minutes and then maintaining at 98 to 100° C. for 20 to 40 minutes; and (2) a method of thawing a frozen packaged sushi characterized by comprising thawing the frozen packaged sushi as described in the above (1) by allowing to stand in an atmosphere at 5 to 30° C. for 2 to 10 hours.

### TECHNICAL FIELD

This invention relates to a frozen packaged sushi and a method of thawing the frozen packaged sushi, and it more specifically relates to a frozen packaged sushi, which can be thawed at room temperature and a method of thawing the frozen packaged sushi.

### TECHNICAL BACKGROUND

Rice can be cooked by boiling rice in water. However, if such cooked rice is left at room temperature for a long time, the delicious flavor of the rice will be lost and the preservative quality will also deteriorate. As a means to reducing such problems, sushi rice (rice for sushi), which is made of cooked rice containing vinegar, is publicly known. Most sushi is originally cooked with raw ingredients such as fish or the like. Thus, the preservative quality of sushi used to be poor so that sushi had to be soon eaten in a sushi shop or the like. However, the latest advancement in freezing technology has made it possible to extend its applications to takeout sushi, train lunches (a boxed meal sold at stations or on trains), airplane meals, or the like.

However, there are still problems when the applications are extended to train lunches, airplane meals, or the like in which the sushi rice becomes dry or wet due to the moment-to-moment change in moisture conditions during the period of natural thawing or in preservation.

An alternative method to overcome the dryness and wetness of the cooked rice for sushi is thawing the rice in a microwave oven.

However, a microwave oven is too heavy to be easily carried on an airplane, and the electrical waves generated from a microwave oven may produce improper operating signals for the electronic devices on the airplane. Also, a microwave oven will overheat the raw ingredients of the sushi such as Japanese maguro (tuna) and thus deteriorate the taste of the sushi.

Thus, it is expected that frozen packaged sushi and a method of thawing frozen packaged sushi in which the taste will not deteriorate even if the sushi is naturally thawed at room temperature can be realized without using a microwave oven.

Patent Document 1 discloses a prior art in connection with a method for naturally thawing frozen packaged sushi with little deterioration in taste, even if such sushi is moderately thawed, and that the quality control for freezing such sushi is easy. Patent Document 1 also discloses a method for producing sushi rice in which the main ingredients of the additives are gelatin and oligosaccharide which are added while producing the sushi rice.

Patent document 1: JP2000-316499 (publication of patent application)

### DISCLOSURE OF INVENTION

### Problems to be Resolved by the Invention

However, the conventional method of natural thawing still has problems, in that deterioration in taste cannot be satisfactorily prevented or that chemicals used for natural thawing are difficult to obtain.

Thus, this invention is aimed in providing a frozen packaged sushi which can be naturally thawed at room temperature and a method of thawing the frozen packaged sushi by controlling the sugar content in sushi rice and in improving the method of cooking rice to be used for sushi.

### Means of Solving the Problems

This invention is made to achieve the aforementioned objectives and has the following features.
(1) The frozen sushi which is packaged and sealed in a plastic film is characterized in that the sugar content of the rice for frozen packaged sushi is 7.0 to 12.0 weight percent.
(2) The frozen sushi which is packaged and sealed in a plastic film is characterized in that sushi rice that can tolerate a change in temperature, rising from room temperature to 98 degrees C. for 10±2 minutes and kept at 98 to 100 degrees C. for 20 to 40 minutes, is used.
(3) The frozen sushi which is packaged and sealed in a plastic film is characterized in that the sugar content of the rice for frozen packaged sushi is 7.0 to 12.0 weight percent, and that sushi rice that can tolerate a change in temperature, rising from room temperature to 98 degrees C. for 10±2 minutes and kept at 98 to 100 degrees C. for 20 to 40 minutes, is used.
(4) The method of thawing the frozen packaged sushi described in the above (1) to (3) is characterized in that the thawing is conducted in an atmosphere of temperature between 5 and 30 degrees C. for 2 to 10 hours.
(5) The frozen packaged sushi described in the above (1) to (3) is characterized in that those sushi are selected from among Nigiri-zushi (a small portion of vinegared rice with raw fish and seafood on top), Maki-zushi (a sushi roll), Inari-zushi (vinegared rice stuffed in a bag made of fried bean curd), and Oshi-zushi (a lightly-pressed piece of sushi topped with cooked ingredients).
(6) The thawing method described in the above (4) is characterized in that the sushi are selected from among Nigiri-zushi, Maki-zushi, Inari-zushi, and Oshi-zushi.
(7) The frozen packaged sushi described in the above (1) to (3) is characterized in that the sugar content of the sushi is adjusted by adding sucrose, trehalose, and reduced starch syrup.
(8) The frozen packaged sushi described in the above (1) to (3) is characterized in that the sugar content other than sucrose is added into the water for cooking the rice.
(9) The frozen packaged sushi described in the above (4) is characterized in that the sugar content other than sucrose is added into the water for cooking the rice.

The following is the reason why natural thawing is enabled by increasing the sugar content in this invention.

Rice consists of starch as a major ingredient. Starch is in a state of crystalline beta starch at room temperature. When heated, the crystalline beta starch changes to a noncrystalline alpha starch so that the rice becomes tasty.

However, if the cooked rice is kept at room temperature for a long time, the alpha starch becomes beta starch again, and then the taste will deteriorate. As a method to prevent such a deterioration in taste, the frozen packaged sushi is placed in hot water, or in a microwave oven so as to revert the temperature of the sushi rapidly back to room temperature, thus keeping the packaged sushi in the appropriate temperature zone to prevent the alpha starch from becoming the beta starch. In other words, it is understood that if the frozen packaged sushi is naturally thawed at room temperature for a long time, the sushi will have been kept in an inappropriate temperature zone, which will easily cause the alpha starch to become beta starch thus causing the taste of the sushi to deteriorate. Also, the taste rapidly deteriorates at 2 to 5 degrees C. below zero as well as at room temperature. Thus, to prevent the deterioration of taste, it is preferable to prevent water evaporation and to keep the sushi fresh by cooling it approximately at 20 degrees C. below zero.

In general, the rice that is used for sushi is prepared by drizzling the cooked rice with mixed with sugar and salt, and then the sushi rice and this vinegar should be mixed together. In this invention, the sugar content of the sushi rice is to be kept between 7.0 and 12.0% by adding trehalose and reduced starch syrup, as well as sucrose to the vinegar so as to control change in the beta starch and to prevent the deterioration in taste even if natural thawing is conducted. In other words, adding the sugar content influences the water content of the sushi rice, making the initial temperature of melting lower and shortens the period of inappropriate time for the sushi rice to be kept so that the taste is prevented from deteriorating.

In general, the sugar content of the sushi rice is around 1.0 to 6.3%, and the sugar content is adjusted mainly by adding sucrose. In this invention, the sugar content of the sushi rice is adjusted to 7.0 to 12.0%. When the sugar content is below 7.0%, the preventive effect of the deterioration of taste is less. And when the sugar content of the sushi rice exceeds 12.0%, the sweetness becomes too strong and not preferable for the sushi rice.

Natural thawing in this invention is conducted by placing the frozen packaged sushi in an atmosphere of 5 to 30 degrees C. for 2 to 10 hours. The reason why the range in temperature of 5 to 30 degrees C. is specified is that this range is preferable as room temperature. Also, it is necessary to set the period of time as from 2 to 10 hours, as mentioned above, in order to make the temperature of the sushi frozen at about 20 degrees C. below zero, closer to room temperature. Also, this length of time (2 to 10 hours) is preferable for thawing the frozen sushi which is sealed in plastic since the surrounding humidity may produce dew condensation.

In this invention, the sugar content means a contained amount of a group of sugars such as sucrose, reduced starch syrup, glucose, trehalose, oligosaccharide, maltose, fructose, or the like. Since the sugar content of sucrose, reduced starch syrup, trehalose, or the like which is added to adjust the sugar content is already fixed, sugars such as sucrose, trehalose, reduced starch syrup, or the like should be accordingly added to obtain the specific sugar content. Hence, mainly sucrose is added to vinegar for sushi in general. The sugar content to be used for this invention is increased by preferably adding sucrose until the level that is conventionally used. To increase the sugar content, it is preferable to add, for example, reduced starch syrup or trehalose. In this invention, if the sugar content is controlled by adding sucrose only, such sushi rice will become too sweet. In addition, it is possible to add a pH adjuster such as sodium citrate to stabilize trehalose or reduced starch syrup. The amount of the pH adjuster should be around 0.01 to 0.10%

In this invention, the cooked rice is defined as a rice kernel which is boiled with water, while the sushi rice is defined as vinegared cooked rice which is an ingredient for sushi. In order to obtain cooked rice, firstly wash the raw rice in water to clean it of dirt and the excessive rice bran that is produced during the milling of the rice. Drain the excessive water and put the rice into a rice kettle. Then, add some water which contains a sugar content other than sucrose preferably like trehalose or reduced starch syrup, and mix it together until a thin layer of water rises above the surface of the rice kernels.

Immediately after covering the rice kettle with a lid, heat the rice kettle for 10±2 minutes until the temperature of the water in the kettle reaches the boiling point, 98 degrees C. or higher. Then, continue moderately heating the kettle so as to keep the water boiling for 20 to 40 minutes. It is not preferable to heat the water rapidly or too slowly. It is better to moderately heat the kettle to the boiling point for 20 to 40 minutes. In the final process, heat the kettle over a comparatively high heat so that the excessive water in the rice will completely evaporate. If the rice is left as it is, the rice will cook softly and almost all of the excessive water will evaporate from the rice kernels.

To make rice for sushi from cooked rice, it is necessary to drizzle the sushi vinegar containing vinegar, salt and sugar over the cooked rice. Alternatively, it is possible to use sushi vinegar containing sugars such as sucrose as well as trehalose and reduced starch syrup, together with vinegar and salt. As for the sugar content, it is necessary to adjust the added amount each of sucrose, trehalose, reduced starch syrup or the like so that the sugar content of the sushi vinegar should measure between 7.0 and 12.0%. It is preferable to adjust the difference between the sugar content of the sushi rice in this invention and ordinary sushi rice, with the amount of trehalose, reduced starch syrup or the like to be added instead of sugar. It is easy to calculate the necessary added amount of a sugar such as sucrose, trehalose, reduced starch syrup or the like if the specifics that are used in the sushi vinegar are identified. If the sugar content to be added cannot be calculated because the sugar content of the ingredient is not identified, then it will be possible to analyze the sugar content to be added by using a conventional method such as high performance liquid chromatography (HPLC), or the like. Also, an appropriate amount of salt about 0.6 to 1.2% is added, and an appropriate amount of vinegar about 6.5 to 9.0% is added. The amount of vinegar is the additional amount of brewed vinegar itself. To adjust the flavor of the vinegar, it is possible to add a fermented condiment, preferably in quantity of about 0.05 to 0.50%. A fermented condiment is a condiment obtained from grain fermentation.

Thus, the rice obtained by the above process is used for sushi. Such rice can be used for Nigiri-zushi, Inari-zushi, Maki-zushi and Oshi-zushi. Nigiri-zushi consists of a small rounded rectangularly shaped piece of sushi rice with sushi ingredients added such as tuna, sea bream, cuttlefish, octopus, scallop, shrimp, conger eel, sliced roll egg, or the like on top of the rice. Inari-zushi consists of sushi rice stuffed in a bag made of a flavored fried bean curd.

Maki-zushi consists of sushi rice placed on a piece of dried layer seaweed, with a fried roll egg, and then slices and sticks of prepared fish and meat or seasoned gourd strips are placed thereon. These ingredients are then cylindrically rolled up and cut into pieces, while the fried egg roll and the cooked or/and raw fish and meat as well as cooked gourd strips or the like are placed in the center of the sushi. Dried layer seaweed is spirally placed therein, and the sushi rice is placed between the dried layer seaweed in a cylindrical shape. Oshi-zushi consists of cooked or/and raw fish and meat placed on the sushi rice and pressed and hardened until it becomes a rectangular solid.

To package the sushi that is obtained through the above processes, it is preferable to seal the sushi within a plastic film and to place it in a plastic container. Plastic containers include those made of polyolefin, polyamide, polystyrene, polyester or the like. To prevent each sushi from losing its shape due to contact with the other sushi in the package, it is possible to provide partitions, which partially rise up in the plastic container, or it is possible to provide concavities and convexities on the bottom of the container so as to reduce the surface areas of the sushi touching each other. Plastic films to be used for sealing the sushi include films made of polyamide or polyester. As a method for sealing the sushi with the plastic films, it is possible to use ultrasonic sealing, electronic sealing, heat sealing, or the like. At the same time, it is possible to encapsulate oxygen absorbents to prevent oxidization. Such employable oxygen absorbents include ferric oxide or a chemical compound of the titanium series, which can be easily obtained on the general market.

The frozen packaged sushi obtained through the above process is preferably stored at 15 degrees C. below zero to 30 degrees C. below zero. If the storing temperature is over 15 degrees C. below zero, the taste may be deteriorated, and if the temperature is lower than 30 degrees C., it may take a longer time to thaw the sushi until it becomes normal temperature.

To use the sushi for food, the frozen packaged sushi must be thawed to room temperature. To thaw the frozen sushi to room temperature, it is possible to use a microwave oven, or to put the sushi in the hot water, or to leave the sushi at room temperature until it naturally thaws. To thaw frozen sushi at room temperature, the sushi should be left at 5 to 30 degrees C. for 2 to 10 hours.

### Effect of the Invention

(1) The frozen packaged sushi in this invention can be naturally thawed at room temperature without using a microwave so that the sushi can be served as an in-flight meal on a plane.

(2) The frozen packaged sushi in this invention is safe since special additives are not used.

(3) The texture of the frozen packaged sushi in this invention is similar to that of ordinary sushi since special and new additives are not used.

### PREFERRED EMBODIMENT OF THIS INVENTION

The invention specifically described here is based on these embodiments.
How to cook white rice.

Put 6000 parts by weight (pbw) of white rice, 180 pbw of trehalose, 69 pbw of reduced starch syrup, 7 pbw of pH adjuster and 6248 pbw of water in a rice kettle, and then put in 50 pbw of salad oil. Heat the kettle to the boiling point in 9 minutes. After 25 minutes of moderate boiling, heat the rice kettle over a high heat again for one minute to reduce the water content of the rice. After this, spread the cooked rice to cool it. FIG. 1 shows the temperature curve of the rice kettle, showing that it takes 10±2 minutes until the temperature reaches 98 degrees C.
How to make sushi rice

Mix 124 pbw of salt, 873 pbw of sugar and 21 pbw of fermented condiment with 1,208 pbw of brewed vinegar (acid degree: 4.23±0.04 w/v), together with the cooked rice.

As a comparative reference, a method for cooking ordinary sushi rice is described here.

Put 6,000 pbw of white rice and 5921 pbw of water together with 50 pbw of salad oil in a rice kettle and heat it to a boil in 11 minutes. After 25 minutes at a moderate boil, heat the rice kettle over a high heat again for one minute to reduce the water content of the rice.
How to make ordinary sushi rice

Mix 122 pbw of salt, 872 pbw of sugar and 21 pbw of fermented condiment with 995 pbw of brewed vinegar to obtain sushi vinegar, and then mix the sushi vinegar with the above ordinarily cooked rice to become ordinary sushi rice.

CHART 1

| | Sushi rice of this invention | | Sushi rice not of this invention | | |
|---|---|---|---|---|---|
| | Blending qty. | Blending ratio | Blending qty. | Blending ratio | Difference |
| Ingredients | (gram) | (%) | (gram) | (%) | (%) |
| Water | 6248 | 42.27 | 5921 | 42.35 | −0.08 |
| Rice | 6000 | 40.59 | 6000 | 42.92 | −2.33 |
| Brewed | 1208 | 8.17 | 995 | 7.11 | 1.06 |
| vinegar | | | | | |
| Sucrose | 873 | 5.91 | 872 | 6.24 | −0.33 |
| Reduced | 69 | 0.47 | 0 | 0 | 0.47 |
| starch syrup | | | | | |
| Trehalose | 180 | 1.22 | 0 | 0 | 1.22 |
| Salt | 124 | 0.84 | 122 | 0.87 | −0.03 |
| Oil | 50 | 0.34 | 50 | 0.36 | −0.02 |
| Fermented | 21 | 0.14 | 21 | 0.15 | −0.01 |
| condiment | | | | | |
| pH Adjuster | 7 | 0.05 | 0 | 0 | 0.05 |
| TOTAL | 14780 | 100 | 13981 | 100 | |

Chart 1 shows that the sugar content of the products in this invention is high.

How to make Anago-zushi (Conger eel sushi)

Anago-zushi consists of sushi rice obtained through the above-described process together with these ingredients.

Sushi rice: 210 grams,

Sushi-teri (sauce for Anago-zushi): 20 grams,

A small piece of dried layer seaweed: 1 piece and

Green layer powder: 0.3 grams

FIG. 2 shows Anago-zushi.

After freezing two different types of Anago-zushi, one made by this invention and one not made by this invention at 20 degrees C. below zero, four different cases of thawing below were conducted, as shown below with the texture of the rice in each case having been examined.
Case 1: Thawing at 20 degrees C. by using an airflow wind for three and a half hours to four hours.
Case 2: Thawing at 20 degrees C. by using an airflow wind for six and a half hours to six hours fifty minutes.
Case 3: Thawing at 10 degrees C. by not using an airflow wind for eight hours, and
Case 4: Thawing at 10 degrees C. by not using an airflow wind for 15 hours.

The results of the texture tests are shown here.

CHART 2

| | | | Sushi rice | Sushi rice for |
|---|---|---|---|---|
| | | | in this | reference |
| | | | invention | example |
| Case 1 | 20 degrees C. | Texture | E | H |
| | by using an | Thawing time | 3 hr. 20 min. | 4 hrs. |
| | airflow | | | |
| Case 2 | 10 degrees C. | Texture | G | Hard |
| | by using an | Thawing time | 6 hr. 30 min. | 6 hrs. 50 min. |
| | airflow | | | |
| Case 3 | 20 degrees C. | Texture | G | NG |
| | by not using an | Thawing time | 8 hrs. | 8 hrs. |
| | airflow | | | |
| Case 4 | 10 degrees C. | Texture | H | NG |
| | by not using an | Thawing time | 15 hrs. | 15 hrs. |
| | airflow | | | |

Note:
1. Thawing time: Period of time when the temperature reaches 5 degrees C.
2. Texture: E = Excellent, G = Good, H = Hardened, NG = Not Good

Anago-zushi made of the inventive sushi rice proved that the textures tested in Cases 1 to 3 were still excellent or good after natural thawing at room temperature.

FIG. 3 shows Inari-zushi and Maki-zushi made of the same types of sushi rice as described above.

FIG. 4 shows Nigiri-zushi made of the same type of sushi rice as described above.

The same tests in Cases 1 to 4 were conducted for Inari-zushi and Maki-zushi in FIG. 3, and Nigiri-zushi in FIG. 4. Cases 1 to 3 showed that the texture of sushi made of its inventive rice was excellent.

FIG. 5 shows the temperature curve during thawing. The taste of the ordinary sushi rice rapidly deteriorated at 2 to 15 degrees below zero. However, the inventive sushi rice did not deteriorate at 10 to 15 degrees C. below zero, but slowly deteriorated at 2 to 10 degrees below zero and deteriorated only at 2 to 5 degrees C. below zero.

### INDUSTRIAL APPLICABILITY

The frozen packaged sushi in this invention can be naturally thawed so that it can be used for in-flight meals or as take-out sushi without having to heat in a microwave oven. Therefore, this invention can also contribute to the betterment of the food industry.

### BRIEF DESCRIPTIONS OF THE DRAWINGS

FIG. 1 shows the curves of the increasing its temperature of rice as it is being cooled.

FIG. 2 is a top view of Anago-zushi

FIG. 3 is a top view of Inari-zushi and Maki-zushi.

FIG. 4 is a top view of Nigiri-zushi.

FIG. 5 shows the temperature curve of naturally thawing sushi.

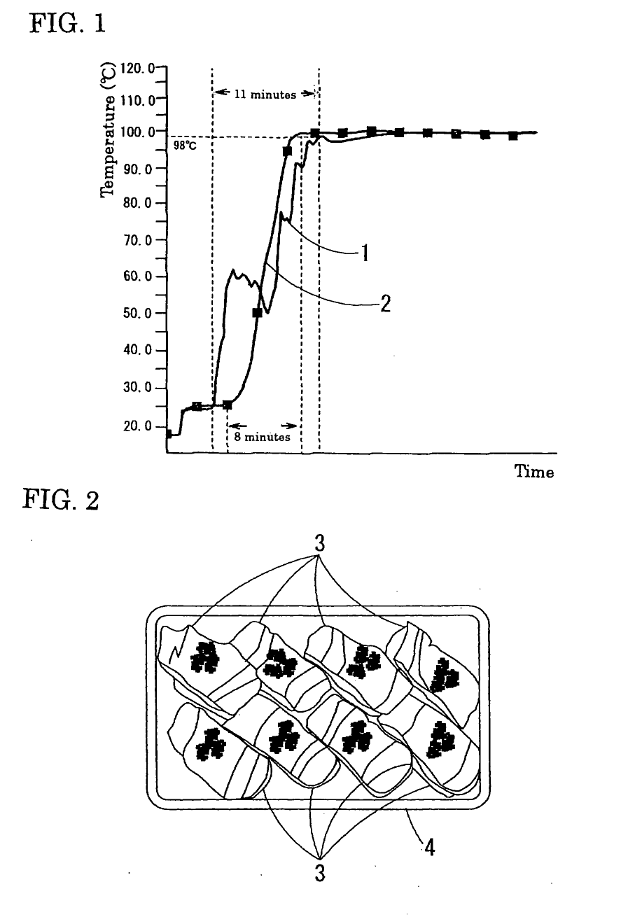

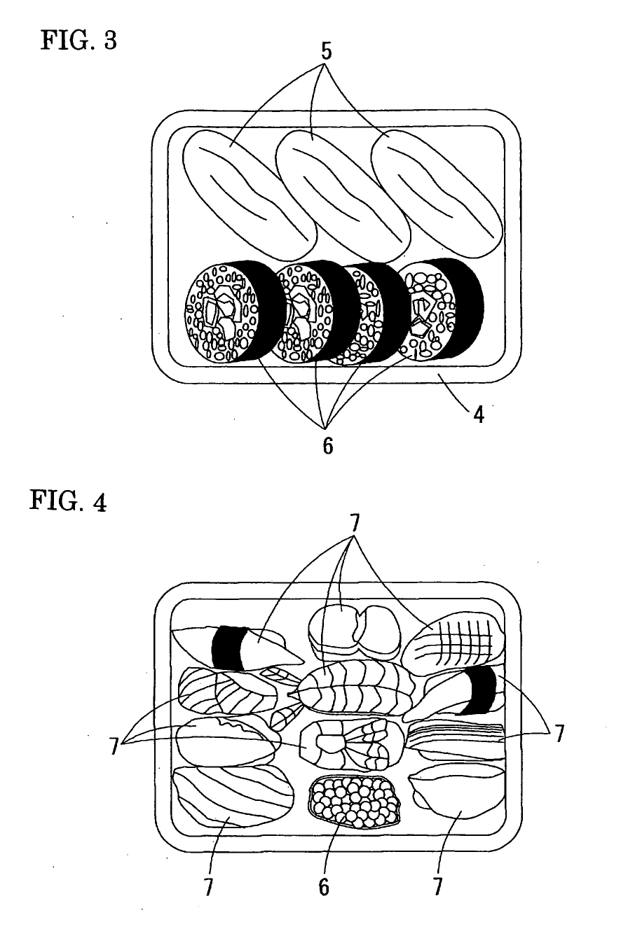

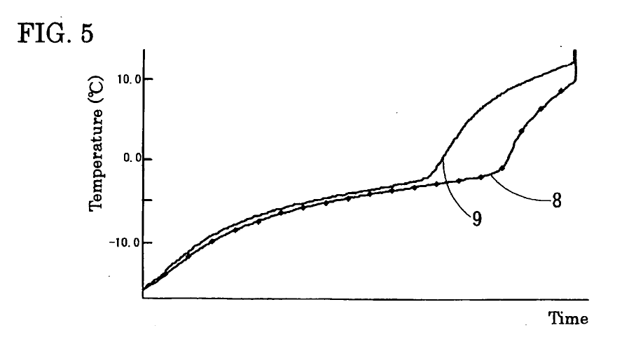

### EXPLANATION OF NUMBERS SHOWN IN THE DRAWINGS

1. The temperature curve showing the temperature inside the rice kettle at the bottom of the rice.
2. The temperature curve showing the temperature inside the rice kettle at the top of the rice.
3. Anago-zushi
4. Plastic container
5. Inari-zushi
6. Maki-zushi
7. Nigiri-zushi
8. The temperature curve showing the temperature during the thawing of normal sushi.
9. The temperature curve showing the temperature during the thawing of the inventive sushi.

What is claimed is:

1. A frozen packaged sushi which is sealed in a plastic film characterized in that the sugar content of the rice for frozen packaged sushi is 7.0 to 12.0 weight percent.

2. A frozen packaged sushi which is sealed in a plastic film characterized in that the sugar content of the rice for frozen packaged sushi is 7.0 to 12.0 weight percent and that sushi rice that can tolerate a change in temperature, rising from room temperature to 98 degrees C. for 10±2 minutes and kept at 98 to 100 degrees C. for 20 to 40 minutes, is used.

3. A method of thawing the frozen packaged sushi described in the above claim 1 or 2 characterized in that the thawing is conducted in an atmosphere of temperature between 5 and 30 degrees C. for 2 to 10 hours.

4. A frozen packaged sushi described in the above claim 1 or 2 characterized in that those sushi are selected from among Nigiri-zushi (a small portion of vinegared rice with raw fish and seafood on top), Maki-zushi (a sushi roll), Inari-zushi (vinegared rice stuffed in a bag made of fried bean curd), and Oshi-zushi (a lightly-pressed piece of sushi topped with cooked ingredients).

5. A thawing method described in the above claim 3 characterized in that the sushi are selected from among Nigiri-zushi, Maki-zushi, Inari-zushi, and Oshi-zushi.

6. A frozen packaged sushi described in the above claim 1 or 2 characterized in that the sugar content of the sushi is adjusted by adding sucrose, trehalose, and/or reduced starch syrup.

7. A frozen packaged sushi described in the above claim 1 or 2 characterized in that the sugar content other than sucrose is added into the water for cooking the rice.

8. A method of thawing the frozen packaged sushi described in the above claim 7 characterized in that the thawing is conducted in an atmosphere of temperature between 5 and 30 degrees C. for 2 to 10 hours.
